(19) United States
(12) Patent Application Publication
(10) Pub. No.: US 2008/0237916 A1
(43) Pub. Date: Oct. 2, 2008

(54) METHOD FOR STRETCHING POLYMER FILM

(75) Inventor: Shinsuke AOSHIMA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Tokyo (JP)

(21) Appl. No.: 12/058,647

(22) Filed: Mar. 28, 2008

(30) Foreign Application Priority Data
Mar. 28, 2007 (JP) 2007-084428

(51) Int. Cl. B29C 55/00

(52) U.S. Cl. 264/165

(57) ABSTRACT

A rear end portion of a leading TAC film and a front end portion of a following TAC film are dissolved in acetone and connected. After being stretched in a tenter, the TAC films are sent to an edge slitting device. In the edge slitting device, both side edges of the TAC films that are held with clips are slit along slit lines. The slit side edges are cut into pieces by a cutter blower and then shredded into chips by a crusher. Since the slit side edges of the leading and following TAC films are welded with acetone, they can be recycled as being connected.

### FIELD OF THE INVENTION

The present invention relates to a method for stretching polymer films.

### BACKGROUND OF THE INVENTION

In recent years, liquid crystal displays have been rapidly developed and spread. This trend caused an increase in demand for cellulose acylate films, especially triacetyl cellulose (TAC) films that are used as a protective film for the liquid crystal displays. Along with the increase in demand, the productivity of the TAC films is desired to be improved. The TAC films are often produced according to the following method. At first, a dope including TAC and a solvent is cast using a casting die onto a continuously running support to form a casting film. The casting film is dried or cooled to develop its self-supporting properties. After having possessed the self-supporting properties, the casting film is peeled from the support, and then dried and wound as a TAC film. According to such solution casting method, the produced film has few foreign substances mixed therein and has excellent optical properties, as compared to films produced according to a melt extrusion method.

In the solution casting method, the support for the dope may be a belt or a drum. To improve the casting speed, the drum is more preferred as compared to the belt. The casting film on the support is dried, or cooled and gelated in order to develop the self-supporting properties. Meanwhile, the film is stretched in order to control the optical properties, especially the retardation characteristics, of the produced TAC film.

Optimum speed of the film production and that of the film stretching vary from each other. The film production speed, that is, the casting speed is generally slower than the film stretching speed. Therefore, when the stretching speed is adjusted to the casting speed, the film may not be sufficiently stretched to improve the optical properties of the produced TAC film. In view of this, it is proposed that the film is stretched off-line, that is, outside a solution casting line (see, for example, Japanese Patent Laid-open Publication No. 2002-311240).

As disclosed in the Japanese Patent Laid-open Publication No. 2002-311240, when the film is stretched off-line, that is, independently from the solution casting line, it is preferable to stretch the film continuously so as to perform the film stretching effectively. In order to stretch the film continuously, a rear end of a leading film and a front end of a following film are connected using a connection tape. However, the connection tape cannot be recycled for preparing the dope since the TAC film and the connection tape are generally made from different materials. Therefore, when the connection tape is used to connect the films, the connection tape needs to be removed from the films. When the connection tape is removed, the slit edge of the leading film and the slit edge of the following film fall apart, which lowers the workability in recovering the slit edges. Such problems are not limited to the TAC film production, but may arise in any polymer film production where the slit film edges are recycled for preparing the dope.

### SUMMARY OF THE INVENTION

It is an object of the present invention to provide a method for stretching polymer films which improves the workability in recovering slit film edges.

In order to achieve the above and other objects, a method according to the present invention for stretching polymer films in width directions thereof includes connecting step, supplying step, stretching step, slitting step, and recovering step. In the connecting step, a rear end of leading polymer film and a front end of following polymer film are connected. In the supplying step, the connected polymer films are continuously supplied. In the stretching step, the supplied polymer films are stretched by being held at both side edges thereof with clips. The polymer films are conveyed by the clips during the stretching step. In the slitting step, the side edges are slit from main parts of the polymer films after the stretching step. The main part is a center part in the width direction of the polymer film between the side edges. This main part is going to be an end product. In the recovering step, the slit side edges are recovered.

The connecting step is preferably performed using polymer solvent, a heat sealer, an ultrasonic joining device, or a laser welding device.

According to the present invention, the slit edge of the leading film and the slit edge of the following film are connected when they are recovered. Owing to this, the workability in recovering the slit edges can be improved. Moreover, the slit edges do not have the connection tape attached, and therefore saving the trouble of removing the connection tape. Owing to this, the workability in recovering the slit edges can be improved.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a schematic view illustrating an off-line stretching device;

FIG. 2 is a schematic view illustrating a tenter;

FIG. 3 is a side elevational view illustrating a clip;

FIG. 4 is a perspective view illustrating a leading TAC film, a following TAC film, and a coating area SA;

FIG. 5 is a side elevational view illustrating a heat sealer;

FIG. 6 is a plan view illustrating the leading TAC film, the following TAC film, and welding areas JA;

FIG. 7 is a side elevational view illustrating an ultrasonic joining device; and

FIG. 8 is an explanatory view illustrating a laser welding device.

### DESCRIPTION OF THE PREFERRED EMBODIMENTS

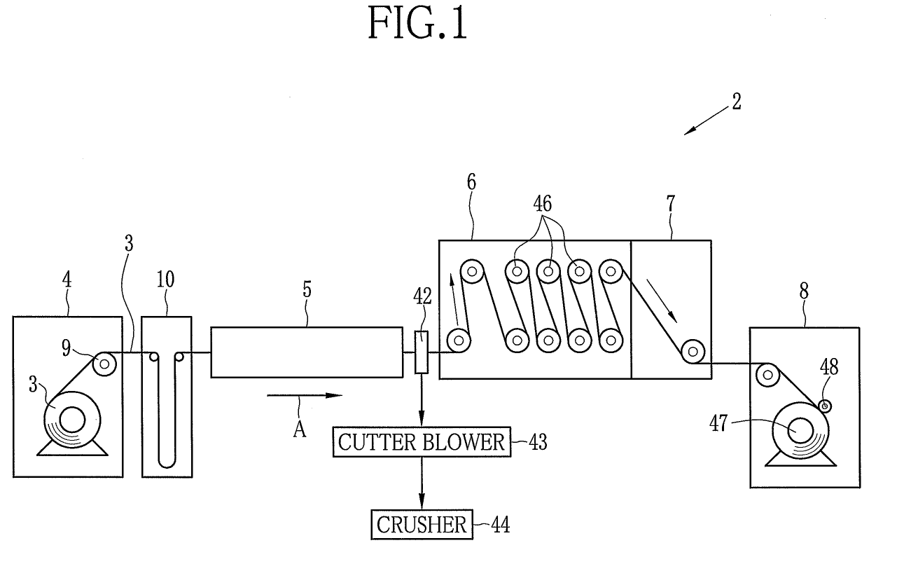

As shown in FIG. 1, an off-line stretching device 2 is for stretching a TAC film 3, and provided with a supplying chamber 4, a tenter 5, a stress relaxation chamber 6 by heating, a cooling chamber 7, and a winding chamber 8. The supplying chamber 4 stores the TAC film 3, which has been produced in a solution casting line, in a roll form. The TAC film 3 is supplied by a supply roller 9 to the tenter 5.

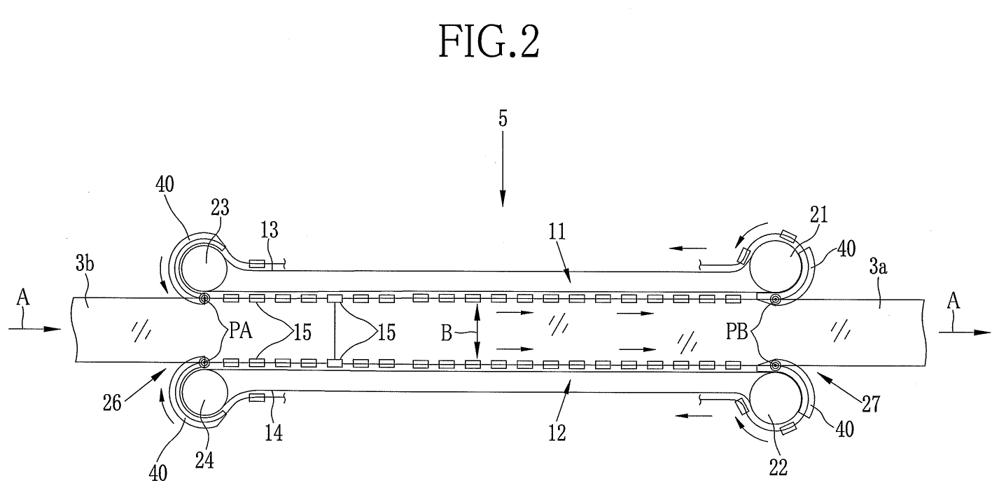

In the tenter 5, both side edges of the TAC film 3 are held with clips 15 (see FIG. 2). While being conveyed at this state, the TAC film 3 is heated and stretched in film width directions B (see FIG. 2). The TAC film 3 is stretched by preferably 100.5% to 300% in the film width directions B with respect to the width of the TAC film 3 before the stretching.

A reservoir 10 is provided between the supplying chamber 4 and the tenter 5. In the reservoir 10, a certain length of TAC film 3 is reserved to form a loop. The certain length is a length enough for connecting the TAC films 3. The film connection is described later. After forming the loop, the TAC film 3 is sent to the tenter 5.

As shown in FIG. 2, the TAC film 3 is conveyed in a convey direction A and stretched in the film width directions B in the tenter 5. The tenter 5 is provided with a first rail 11, a second rail 12, a first chain 13 and a second chain 14 (both are endless chains). The first chain 13 is guided by the first rail 11, and the second chain 14 is guided by the second rail 12. Temperature inside the tenter 5 is kept high. The tenter 5 may be divided into plural zones in the convey direction A as necessary so as to change conditions for heating the TAC film 3 in each zone. For example, the tenter 5 may be divided, from upstream to downstream thereof, into pre-heating zone, heating zone, and stress relaxation zone by heating, in the convey direction A.

The clips 15 are attached to the first and second chains 13 and 14 at certain intervals. While holding the side edges of the TAC film 3, the clips 15 are moved along each rail 11 or 12, and thereby stretching the TAC film 3 in the film width directions B. In this embodiment, the TAC film 3 is stretched in the film width directions B such that the width of the TAC film 3 after the stretching becomes 103% of the width of the same before the stretching. The stretch ratio is not limited to this, but may be appropriately changed in accordance with desired optical properties and the like.

The first chain 13 is bridged across a drive sprocket wheel 21 and a driven sprocket wheel 23, and guided by the first rail 11. The second chain 14 is bridged across a drive sprocket wheel 22 and a driven sprocket wheel 24, and guided by the second rail 12. The drive sprocket wheels 21 and 22 are provided at a tenter exit 27 side, and are driven and rotated by drive mechanisms (not shown). The driven sprocket wheels 23 and 24 are provided at a tenter entrance 26 side.

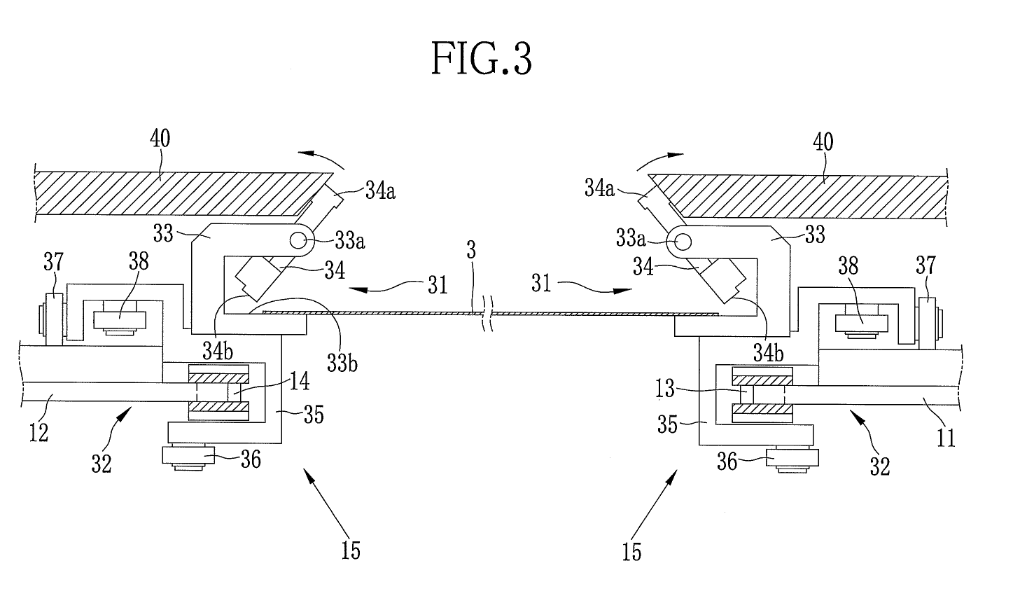

As shown in FIG. 3, each clip 15 is constituted of a clip body 31 and a rail attachment portion 32. The clip body 31 is constituted of a substantially C-shaped frame 33 and a flapper 34. The flapper 34 is rotatably attached to the frame 33 through an attachment shaft 33a. The flapper 34 moves between holding position and releasing position. In the holding position, the flapper 34 becomes vertical. In the releasing position, as shown in FIG. 3, a releasing member 40 contacts and pushes an engagement head 34a of the flapper 34, and thereby tilting the flapper 34 from the vertical position. That is, the flapper 34 swings around the attachment shaft 33a. The flapper 34 is normally in the holding position under its own weight. The TAC film 3 is held between a film holding surface 33b of the frame 33 and a flapper lower surface 34b of the flapper 34. The film holding initiates at a position (holding initiation point) PA (see FIG. 2).

The rail attachment portion 32 is constituted of an attachment frame 35 and guide rollers 36, 37 and 38. The first chain 13 or the second chain 14 is attached to the attachment frame 35. The guide rollers 36, 37 and 38 rotate by contacting with a support surface of the drive sprocket wheel 21 or 22, or a support surface of the first rail 11 or the second rail 12. Owing to this, the clip 15 is guided along the first rail 11 or the second rail 12 without dropping off of the drive sprocket wheel 21 or 22.

The releasing member 40 is arranged near the sprocket wheel 21, 22, 23 and 24 (see FIG. 2). The releasing members 40 near the driven sprocket wheels 23 and 24 contact and push the engagement heads 34a of the flappers 34 of the clips 15 at the position upstream from the position PA, and thereby putting the flappers 34 into the releasing position. Owing to this, the clips 15 can receive the side edges of the TAC film 3. At the time when the clips 15 pass the position PA, the releasing members 40 retract from the engagement heads 34a, and thereby putting the flappers 34 into the holding position. Owing to this, the clips 15 hold the side edges of the TAC film 3. In the same manner, the releasing members 40 near the drive sprocket wheels 21 and 22 put the flappers 34 into the releasing position at the time when the clips 15 pass a position (holding release point) PB. Owing to this, the clips 15 release the holding of the side edges of the TAC film 3.

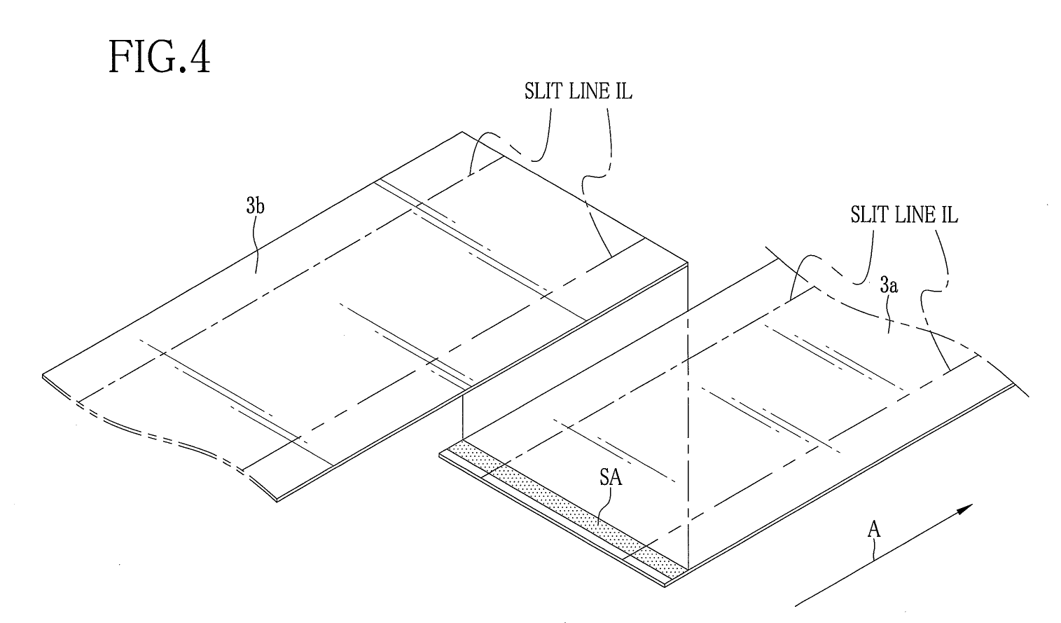

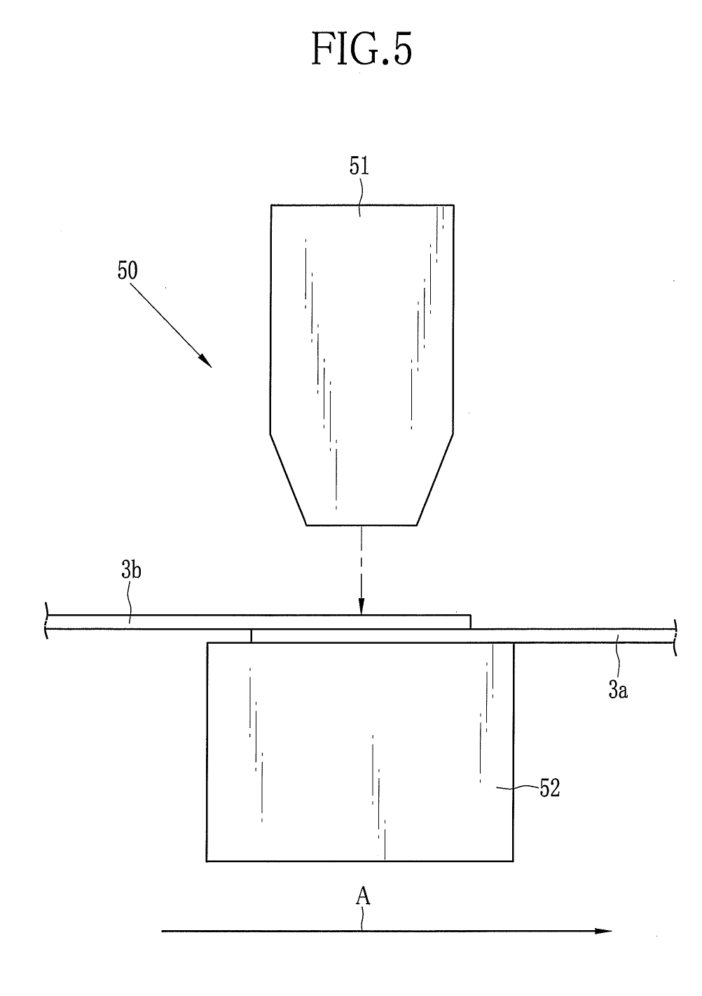

As shown in FIGS. 4 and 5, the TAC films 3 are connected to continuously stretch them in the tenter 5. A rear end portion of the TAC film 3 (leading film 3a), which has been supplied from the supplying chamber 4, and a front end portion of the newly supplied TAC film 3 (following film 3b) are connected using acetone. Acetone is one of the solvents used for preparing the dope in the TAC film production. Acetone is coated by spraying on a coating area SA of the rear end portion of the leading film 3a. The front end portion of the following film 3b is placed on the rear end portion of the leading film 3a, and the layered portion is pressed to be adhered. Owing to this, the films 3a and 3b are welded by acetone and connected. The connection using acetone is performed upstream from the reservoir 10. At the time of the connection, the TAC film 3 that has been reserved in the reservoir 10 is sent to the tenter 5. Owing to this, the film connection can be performed without stopping the film conveyance. The film connection may be performed automatically by machine, or may be performed manually in the case where the off-line stretching device 2 has a simple configuration. Instead of acetone, methyl acetate or dioxolane may also be used for the film connection.

The coating area SA may be provided such that a line on which the rear end portion of the leading film 3a and the front end portion of the following film 3b are connected is tilted (at an angle of 30 degrees, for example) to the film width directions B. In other words, the line on which the leading and following films 3a and 3b are connected may be provided to intersect with the film width directions B at an angle of, for example, 30 degrees. For the film connection, it is also possible to use acetone and a connection tape that stretches along with the TAC films 3 at the time of film stretching. In this case, parts outside from slit lines IL (see FIG. 4) of the leading and following films 3a and 3b, that is, side edges are connected using acetone, and parts between the slit lines IL of the leading and following films 3a and 3b, that is, main parts are connected using the connection tape. The side edges are going to be slit in a later process, and the main parts are going to be a final product.

After the stretching in the tenter 5, the TAC films 3 are sent to an edge slitting device 42 as shown in FIG. 1. The edge slitting device 42 slits both side edges of the TAC films 3 along the slit lines IL (see FIG. 4). The slit side edges are cut into small pieces by a cutter blower 43 and then shredded into chips by a crusher 44. Since the chips are recycled for preparing the dope, the materials are efficiently utilized, and therefore the production cost is reduced.

The side edges slit from the leading and following films 3a and 3b are dissolved in acetone and connected. Since the connection is made using acetone, the side edges can be recycled as they are. Owing to this, the trouble of removing the connection tape is prevented. This improves the workability in recovering the slit side edges. The TAC films 3 whose side edges have been slit by the edge slitting device 42 are sent to the stress relaxation chamber 6.

In the stress relaxation chamber 6, plural rollers 46 are provided. While being conveyed by the rollers 46, the TAC films 3 are heated and thereby relaxing the internal stress thereof. In the stress relaxation chamber 6, an air blower (not shown) sends air at a desired temperature. The temperature of the air is preferably in the range of 20° C. to 250° C. Then, the TAC films 3 are sent to the cooling chamber 7.

In the cooling chamber 7, the TAC films 3 are cooled until the temperature thereof reaches 30° C. or less, and then sent to the winding chamber 8. In the winding chamber 8, the TAC films 3 are wound by a winding roll 47. At the time of winding, a press roller 48 applies tension to the TAC films 3.

Instead of using acetone, the rear end portion of the leading film 3a and the frond end portion of the following film 3b may be connected using a heat sealer shown in FIG. 5.

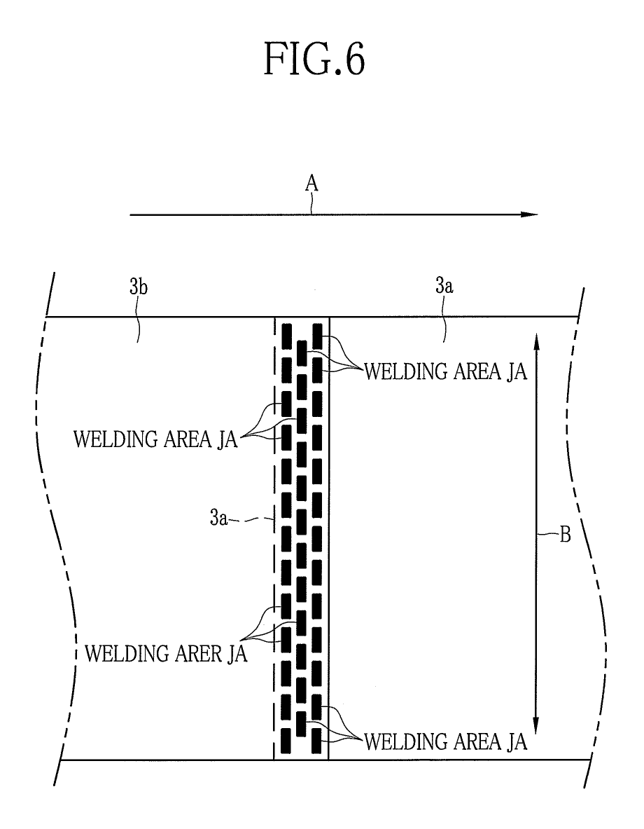

The heat sealer 50 is provided with a seal head 51. The rear end portion of the leading film 3a is placed on a stage 52, and the front end portion of the following film 3b is layered thereon. Then, the seal head 51 is pressed against the films 3a and 3b. The leading and following films 3a and 3b are welded and connected by the effect of the heat conduction. At this time, the films 3a and 3b are connected at a plurality of welding areas JA, as shown in FIG. 6. The films 3a and 3b are connected by the heat sealer 50 such that the line on which the rear end portion of the leading film 3a and the front end portion of the following film 3b are connected is tilted (at an angle of 30 degrees, for example) to the film width directions B. In other words, the line on which the films 3a and 3b are connected may be provided to intersect with the film width directions B at an angle of, for example, 30 degrees. For the film connection, it is also possible to use the heat sealer 50 and the connection tape that stretches along with the TAC films 3 at the time of film stretching. The parts outside from the slit lines IL (see FIG. 4) of the leading and following films 3a and 3b, that is, the side edges are connected using the heat sealer 50. The parts between the slit lines IL of the leading and following films 3a and 3b, that is, the main parts are connected using the connection tape. Instead of the heat sealer 50, an impulse sealer may also be used for connecting the leading and following films 3a and 3b.

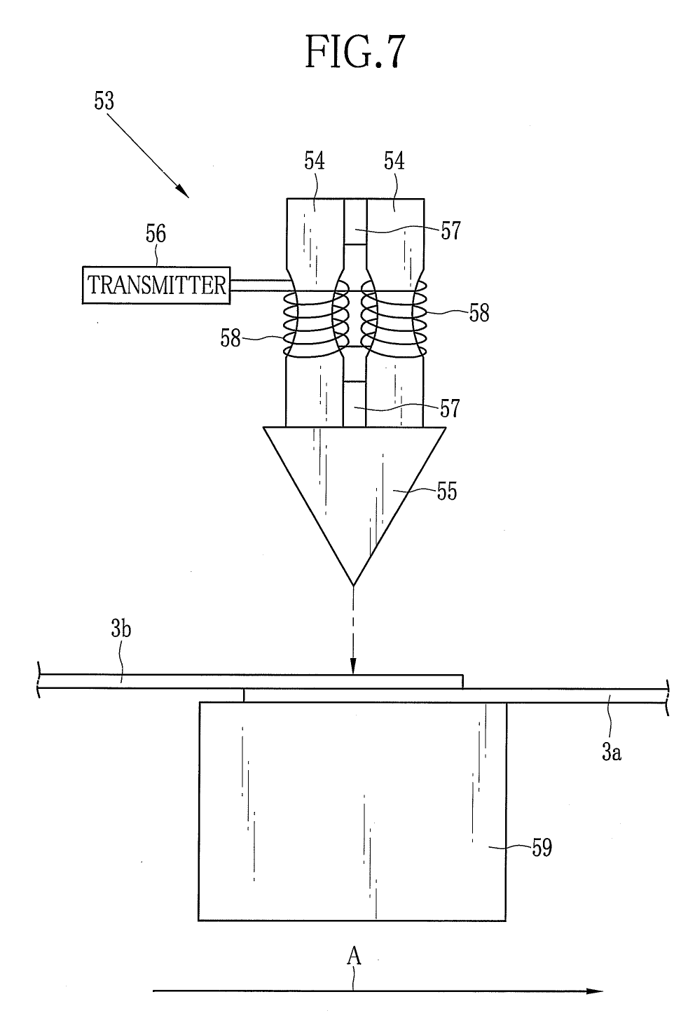

Instead of using acetone, an ultrasonic joining device 53 shown in FIG. 7 may also be used for connecting the leading and following films 3a and 3b.

The ultrasonic joining device 53 mechanically oscillates the TAC films 3 for 20000 to 28000 times per second with amplitude of 0.03 mm. By being oscillated, the TAC films 3 are heated and welded. The ultrasonic joining device 53 is provided with transducers 54, a horn 55, and a transmitter 56. A permanent magnet 57 is provided between the transducers 54. Each transducer 54 is wounded with a coil 58. The transmitter 56 drives the transducers 54 through the coils 58. The transducers 54 convert electric oscillation into mechanical oscillation. The horn 55 amplifies the mechanical oscillation of the transducers 54 and transfers the oscillation to the leading and following films 3a and 3b on a stage 59. Owing to the oscillation, the leading and following films 3a and 3b are heated and welded. At this time, the films 3a and 3b are connected at a plurality of welding areas JA, as shown in FIG. 6. The films 3a and 3b are connected by the ultrasonic joining device 53 such that the line on which the rear end portion of the leading film 3a and the front end portion of the following film 3b are connected is tilted (at an angle of 30 degrees, for example) to the film width directions B. For the film connection, it is also possible to use the ultrasonic joining device 53 and the connection tape that stretches along with the TAC films 3 at the time of film stretching. The parts outside from the slit lines IL (see FIG. 4) of the leading and following films 3a and 3b, that is, the side edges are connected using the ultrasonic joining device 53. The parts between the slit lines IL of the leading and following films 3a and 3b, that is, the main parts are connected using the connection tape.

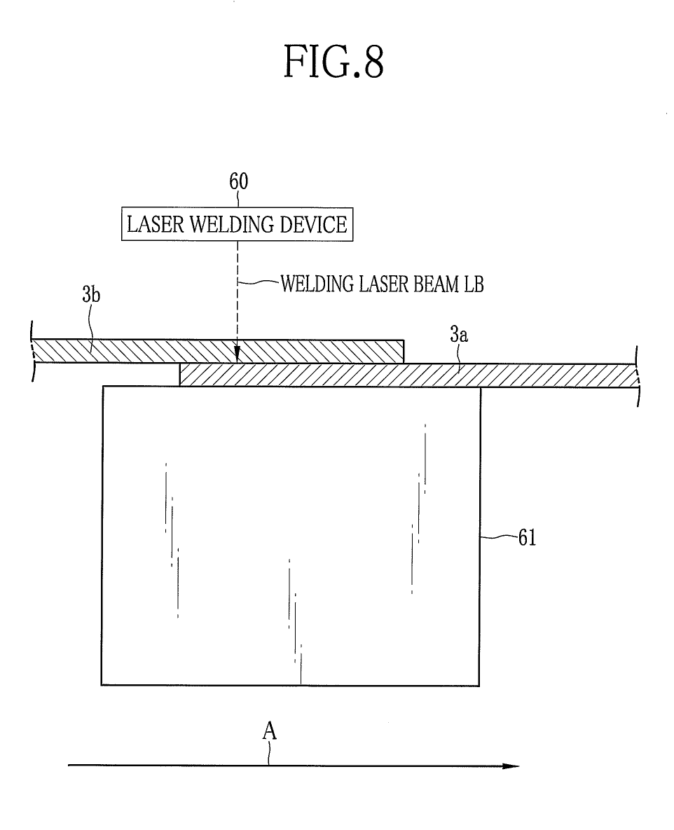

Instead of using acetone, a laser welding device 60 shown in FIG. 8 may also be used for connecting the leading and following films 3a and 3b.

The laser welding device 60 emits a welding laser beam SB while focusing on an upper surface of the leading film 3a (or a lower surface of the following film 3b). When the welding laser beam SB is emitted, the upper surface of the leading film 3a is melted by heat, and the heat is transferred to the lower surface of the following film 3b and melts it. Owing to this, the leading and following films 3a and 3b are welded and connected. At this time, the films 3a and 3b are connected at a plurality of welding areas JA, as shown in FIG. 6. The films 3a and 3b are connected using the laser welding device 60 such that the line on which the rear end portion of the leading film 3a and the front end portion of the following film 3b are connected is tilted (at an angle of 30 degrees, for example) to the film width directions B. For the film connection, it is also possible to use the laser welding device 60 and the connection tape that stretches along with the TAC films 3 at the time of film stretching. The parts outside from the slit lines IL (see FIG. 4) of the leading and following films 3a and 3b, that is, the side edges are connected using the laser welding device 60. The parts between the slit lines IL of the leading and following films 3a and 3b, that is, the main parts are connected using the connection tape.

The TAC film 3 is produced according to the well-known solution casting method such as, for example, a method disclosed in Japanese Patent Laid-open Publication No. 2005-104148. To increase the film production speed, the dope including TAC and the solvent is cast on the cooled drum. The casting film is cooled and gelated to have the self-supporting properties. After having possessed the self-supporting properties, the casting film is peeled. The peeled film is dried in a pin tenter and then wound into a roll form as a TAC film. When the present invention is applied to such TAC film, the TAC film having excellent optical properties can be produced effectively and efficiently.

In this embodiment, the TAC film 3 is used as the example of the polymer film. However, the present invention can also be applied to other kinds of polymer films.

Various changes and modifications are possible in the present invention and may be understood to be within the present invention.

What is claimed is:

1. A method for stretching polymer films in width directions thereof comprising the steps of:
connecting a rear end of leading said polymer film and a front end of following said polymer film;
supplying the connected polymer films continuously;
stretching the supplied polymer films by holding both side edges thereof with clips, said polymer films being conveyed by said clips during said stretching step;
slitting said side edges from main parts of said polymer films after said stretching step, said main part being a center part in the width direction of said polymer film between said side edges, said main part becoming an end product; and
recovering the slit side edges.

2. The method according to claim 1, wherein said connecting step is performed using polymer solvent.

3. The method according to claim 1, wherein said connecting step is performed using a heat sealer.

4. The method according to claim 1, wherein said connecting step is performed using an ultrasonic joining device.

5. The method according to claim 1, wherein said connecting step is performed using a laser welding device.
